(19) United States
(12) Patent Application Publication
(10) Pub. No.: US 2018/0345905 A1
(43) Pub. Date: Dec. 6, 2018

(54) LOCK DEVICE

(71) Applicant: KABUSHIKI KAISHA TOKAI RIKA DENKI SEISAKUSHO, Aichi (JP)

(72) Inventors: Masanori KOSUGI, Aichi (JP); Tetsuya EGAWA, Aichi (JP)

(21) Appl. No.: 15/980,751

(22) Filed: May 16, 2018

(30) Foreign Application Priority Data
May 31, 2017 (JP) 2017-107636

(51) Int. Cl. B60R 25/02; B62D 5/00

(52) U.S. Cl. CPC B60R 25/02; B62D 5/001

(57) ABSTRACT

A lock device includes a lock member arranged in a by-wire turning mechanism that turns a turning wheel by transmitting power of a turning actuator to a turning shaft. The lock member is moved between a lock position where the lock member is engaged with the turning actuator restricting operation of the turning actuator and an unlock position where the lock member is disengaged from the turning actuator permitting operation of the turning actuator.

### CROSS-REFERENCE TO RELATED APPLICATIONS

This application is based upon and claims the benefit of priority from prior Japanese Patent Application No. 2017-107636, filed on May 31, 2017, the entire contents of which are incorporated herein by reference.

### FIELD

This disclosure relates to a lock device for a by-wire turning mechanism that transmits power from a turning actuator to a turning shaft to turn turning wheels and more particularly to a lock device that restricts operation of the turning actuator.

### BACKGROUND

Japanese Laid-Open Patent Publication No. 2016-88339 (paragraph 0017) discloses a rack and pinion type steering device. As described in the publication, there are two types of rack and pinion type steering devices, that is, a single-pinion type that includes a single pinion shaft, and a dual-pinion type that includes two pinion shafts.

With the single-pinion type steering device, when the driver steers a steering member such as a steering wheel and rotates a steering shaft, a rack and pinion mechanism converts the rotational motion to linear motion of a rack shaft. This turns the turning wheels (refer to paragraph 0016 of above publication).

With the dual-pinion type steering device, a torque sensor detects the steering torque applied to the steering member, and an ECU controls and drives an electric motor based on the detected torque. A reduction drive mechanism reduces the speed of the rotation generated by the motor and transmits the rotation to a second pinion shaft. The second pinion shaft converts the rotational motion to linear motion of a rack shaft. This assists steering performed by the steering member (refer to paragraph 0021 of the above publication).

### SUMMARY

The single-pinion type and the dual-pinion type may both include a steering lock device. A steering lock device, for example, actuates a lock rod to fit the lock rod into a lock hole of a steering shaft. This restricts steering with the steering member when the engine is stopped such as when the vehicle is parked. Thus, the steering lock device improves security.

In a by-wire steering device, the steering member is mechanically separated from a turning mechanism that turns turning wheels. Thus, even if the steering lock device were to lock the steering member and restrict movement of the steering member, the turning wheels can still be turned.

One embodiment is a lock device. The lock device includes a lock member arranged in a by-wire turning mechanism that turns a turning wheel by transmitting power of a turning actuator to a turning shaft. The lock member is moved between a lock position where the lock member is engaged with the turning actuator restricting operation of the turning actuator and an unlock position where the lock member is disengaged from the turning actuator permitting operation of the turning actuator.

Other embodiments and advantages thereof will become apparent from the following description, taken in conjunction with the accompanying drawings, illustrating by way of example the principles of the invention.

It is to be understood that both the foregoing general description and the following detailed description are exemplary and explanatory and are not restrictive of the invention, as claimed.

### BRIEF DESCRIPTION OF THE DRAWINGS

The embodiments, together with objects and advantages thereof, may best be understood by reference to the following description of the presently preferred embodiments together with the accompanying drawings in which:

FIG. 1 is a diagram illustrating the principle of a by-wire steering device;

FIG. 2 is a schematic diagram of a drive system that is a turning mechanism;

FIG. 3 is a schematic perspective view illustrating the structure of the turning mechanism in a first embodiment;

FIG. 4 is a diagram illustrating the principle of a lock device for the turning mechanism of FIG. 3;

FIG. 5 is a schematic perspective view illustrating the structure of a turning mechanism in a second embodiment; and

FIG. 6 is a diagram illustrating the principle of a lock device for the turning mechanism of FIG. 5.

### DESCRIPTION OF THE EMBODIMENTS

Embodiments will now be described with reference to the accompanying drawings. Elements in the drawings may be partially enlarged for simplicity and clarity and thus have not necessarily been drawn to scale. To facilitate understanding, hatching lines may not be illustrated.

### First Embodiment

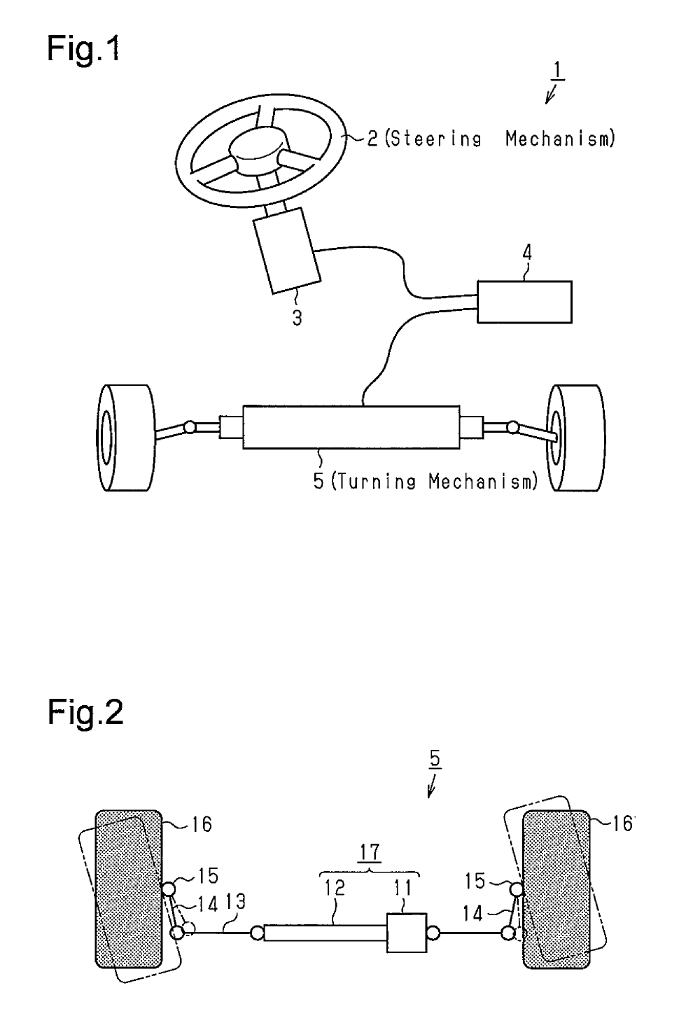

A lock device in accordance with a first embodiment will now be described with reference to FIGS. 1 to 4.

As illustrated in FIG. 1, a steering device 1 includes an input system 2, a detection system 3, a control system 4, and a drive system 5. The input system 2 includes a steering wheel that serves as a steering member. The detection system 3 detects a steering amount of the steering wheel. The control system 4 determines a turning amount of the turning wheels in accordance with the steering amount of the steering wheel. The drive system 5 turns the turning wheels under the control of the control system 4. The steering device 1 is of a by-wire type in which the input system 2, which is a steering mechanism, is mechanically separated from the drive system 5, which is a turning mechanism.

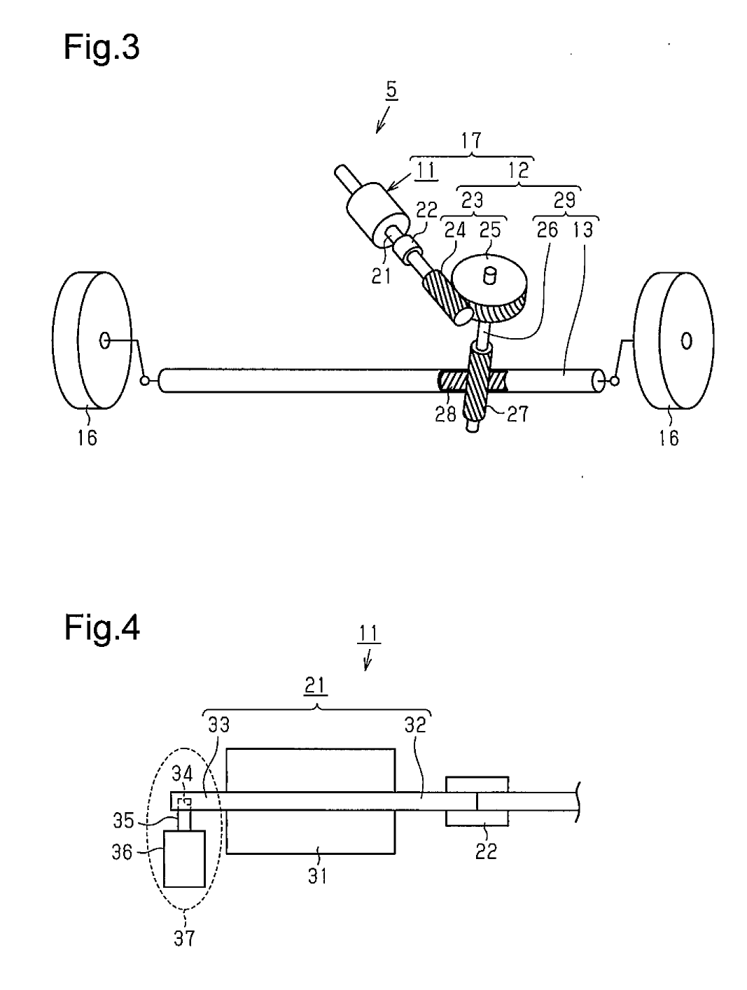

As illustrated in FIG. 2, the drive system 5 includes a motor 11 that serves as a power source. The motor 11 is coupled to a gear mechanism 12 that includes a reduction drive mechanism 23 and a rack and pinion mechanism 29 (refer to FIG. 3). The reduction drive mechanism 23 reduces the speed of the rotation generated by the motor 11. The rack and pinion mechanism 29 converts the rotational motion to linear motion of a rack shaft 13, which serves as a turning shaft, to move tie rods 14 toward the left or right and change the direction of turning wheels 16 about kingpins 15. The motor 11 and the gear mechanism 12 form a turning actuator 17.

As illustrated in FIG. 3, the motor 11 includes an output shaft 21 that is coupled by a joint 22 to the reduction drive mechanism 23. The reduction drive mechanism 23 includes a drive gear 24 that is coupled by the joint 22 to the output shaft 21 of the motor 11 and a driven gear 25 that is meshed with the drive gear 24. One example of the reduction drive mechanism 23 is a worm gearset in which the drive gear 24 is a worm and the driven gear 25 is a worm wheel. The rack and pinion mechanism 29 includes a pinion shaft 26 that is rotated integrally with the driven gear 25 and the rack shaft 13 that includes rack teeth 28 meshed with pinion teeth 27 of the pinion shaft 26.

As illustrated in FIG. 4, the motor 11 includes a motor housing 31, which is fixed to the vehicle body, and the output shaft 21. The output shaft 21 projects out of opposite sides of the motor housing 31. The output shaft 21 includes a first output shaft 32 that extends from the motor housing 31 and is joined with the joint 22 and a second output shaft 33 that extends from the side of the motor housing 31 opposite to the first output shaft 32. The circumferential surface of the second output shaft 33 includes one or more lock holes 34. The second output shaft 33 is one example of a rotation shaft rotated when the motor 11 is driven. Other examples of the rotation shaft include the first output shaft 32, the drive gear 24, the driven gear 25, and the pinion shaft 26. The lock hole 34 is one example of an engagement portion arranged in the rotation shaft (in present example, second output shaft 33). The lock device 37 includes the lock member 35 that is able to be fitted to the lock hole 34.

A lock actuator 36 is fixed to the vehicle body to move the lock member 35. The lock member 35 is, for example, a lock pin. The lock actuator 36 moves the lock member 35 between a lock position where the lock member 35 is fitted to the lock hole 34 and an unlock position where the lock member 35 is separated from the lock hole 34. The lock actuator 36 is controlled by an ECU of the control system 4 or another ECU. In the present example, the lock member 35, the lock actuator 36, and the lock hole(s) 34 of a locked member (in one example, output shaft 21 of motor 11) form the lock device 37.

The operation of the lock device 37 will now be described.

When there is no need to turn the turning wheels 16 such as when the vehicle is parked, the ECU of the control system 4 controls the lock actuator 36 and moves the lock member 35 from the unlock position to the lock position. An urging member such as a spring (not illustrated) elastically urges the lock member 35 toward the output shaft 21 of the motor 11. Thus, when the lock hole 34 lies in the movement path of the lock member 35, the lock member 35 is fitted into the lock hole 34. When the lock hole 34 does not lie in the movement path of the lock member 35, the output shaft 21 is rotated by external force to a position where the lock member 35 is able to be fitted into the lock hole 34.

The lock member 35, when fitted into the lock hole 34, restricts rotation of the output shaft 21 of the motor 11. This restricts operation of the turning actuator 17. Thus, the transmission of power from the motor 11 to the rack shaft 13 is restricted, and the turning wheels 16 of the parked vehicle are locked and cannot be turned.

When the turning wheels 16 need to be turned such as when the vehicle is driven, the ECU of the control system 4 controls the lock actuator 36 and moves the lock member 35 from the lock position toward the unlock position. This separates the lock member 35 from the lock hole 34 and allows the output shaft 21 of the motor 11 to rotate. Thus, the operation of the turning actuator 17 is permitted, and the transmission of power from the motor 11 to the rack shaft 13 is permitted. Accordingly, when driving the vehicle, the steering wheel can be rotated to turn the turning wheels 16 under the control of the control system 4.

The advantages of the first embodiment will now be described.

(1) Engagement of the lock member 35 with the turning actuator 17 restricts operation of the turning actuator 17. This locks the turning wheels 16 when the vehicle is parked so that the turning wheels 16 cannot be turned.

(2) The lock member 35 engages an engagement portion (in one example, lock hole 34) to restrict rotation of a rotation shaft (in one example, second output shaft 33) when the motor 11 is driven. This restricts turning of the turning wheels 16.

(3) The lock member 35 is fitted to the lock hole 34 in the output shaft 21 of the motor 11 to restrict turning of the turning wheels 16. With this structure, the lock device 37 restricts the transmission of power before the reduction drive mechanism 23 reduces the rotation speed. Thus, there is no need for high power when restricting turning of the turning wheels 16. Accordingly, the lock device 37 may be reduced in size.

(4) The output shaft 21 of the motor 11 includes the first output shaft 32, which is coupled to the joint 22, and the second output shaft 33, which is located at the side opposite to the first output shaft 32. The second output shaft 33 includes the lock hole 34. Accordingly, the lock member 35, which is fitted into the lock hole 34 to restrict rotation of the motor 11, is located at the side of the motor 11 where the joint 22 does not exist. Thus, the lock member 35 restricts turning of the turning wheels 16 without interference between the lock member 35 and the joint 22. Further, in comparison with a typical motor in which an output shaft projects from only one side of the motor housing, the location of the lock hole 34 in the second output shaft 33 of the motor 11 increases the degree of freedom for the arrangement of the lock member 35.

(5) The lock member 35 is fitted into the lock hole 34 of the rotation shaft (in one example, second output shaft 33) to restrict turning of the turning wheels 16. Thus, turning of the turning wheels 16 is easily restricted in an ensured manner.

### Second Embodiment

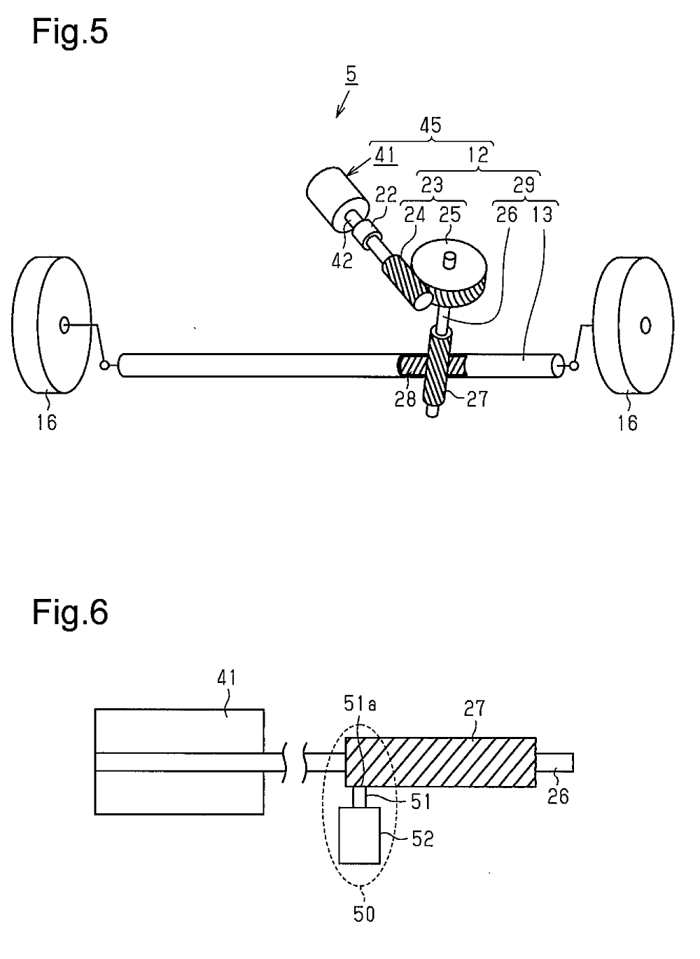

A lock device in accordance with the second embodiment will now be described with reference to FIGS. 5 and 6. The same reference numerals are given to those components that are the same as the corresponding components of the first embodiment. Such components will not be described in detail. The description hereafter will focus on differences from the first embodiment. In the second embodiment, the motor 11 is replaced by a motor 41, the turning actuator 17 is replaced a turning actuator 45, and the lock device 37 is replaced by a lock device 50. The lock device 37 in accordance with the first embodiment locks and restricts rotation of the output shaft 21 of the motor (second output shaft 33) to restrict operation of the turning actuator 17, whereas the lock device 50 in accordance with the second embodiment locks and restricts rotation of the pinion teeth 27 of the pinion shaft 26 to restrict operation of the turning actuator 45.

As illustrated in FIG. 5, the drive system 5, which is a by-wire turning mechanism, uses the motor 41 as a power source instead of the motor 11. The motor 41 includes an output shaft 42 that projects out of only one side of the motor housing. The output shaft 42 of the motor 41 is coupled by the joint 22 to the reduction drive mechanism 23. The lock device 50 (refer to FIG. 6) is arranged on the pinion teeth 27 of the pinion shaft 26 that is rotated integrally with the driven gear 25 of the reduction drive mechanism 23. The motor 41 and the gear mechanism 12 form the turning actuator 45.

As illustrated in FIG. 6, in the lock device 50, the locked member is the pinion shaft 26. The pinion shaft 26 is one example of a rotation shaft rotated when the motor 41 is driven. The pinion teeth 27 correspond to an engagement portion arranged in the rotation shaft (in this case, pinion shaft 26).

The lock device 50 includes a lock member 51 and a lock actuator 52 that moves the lock member 51. The lock actuator 52 moves the lock member 51 between a lock position where the lock member 51 is meshed with the pinion teeth 27 and an unlock position where the lock member 51 is separated from the pinion teeth 27. The distal end of the lock member 51 includes lock teeth 51a arranged at the same pitch as the pinion teeth 27 so that the lock teeth 51a can be meshed with the pinion teeth 27. The lock actuator 52 is controlled by the ECU of the control system 4 or another ECU.

The operation of the lock device 50 will now be described.

When there is no need to turn the turning wheels 16 such as when the vehicle is parked, the ECU of the control system 4 controls the lock actuator 52 and moves the lock member 51 from the unlock position to the lock position. An urging member such as a spring (not illustrated) elastically urges the lock member 51 toward the pinion teeth 27 in a direction intersecting the pinion shaft 26 and pushes the lock teeth 51a against the pinion teeth 27. Thus, when the rotation of the pinion shaft 26 is stopped at a position where the lock teeth 51a can be meshed with the pinion teeth 27, the lock teeth 51a are meshed with the pinion teeth 27. When the rotation of the pinion shaft 26 is stopped at a position where the lock teeth 51a cannot be meshed with the pinion teeth 27, the pinion shaft 26 is rotated by external force to a position where the lock teeth 51a can be meshed with the pinion teeth 27.

The lock teeth 51a, when meshed with the pinion teeth 27, restrict rotation of the pinion shaft 26. This restricts operation of the turning actuator 45. Thus, the transmission of power from the motor 41 to the rack shaft 13 is restricted. This restricts turning of the turning wheels 16 of the parked vehicle.

When the turning wheels 16 need to be turned such as when the vehicle is driven, the ECU of the control system 4 controls the lock actuator 52 and moves the lock member 51 from the lock position toward the unlock position. This separates the lock teeth 51a of the lock member 51 from the pinion teeth 27 and allows the pinion shaft 26 to rotate. Thus, the operation of the turning actuator 45 is permitted, and the transmission of power from the motor 41 to the rack shaft 13 is permitted. Accordingly, when driving the vehicle, the steering wheel can be rotated to turn the turning wheels 16 under the control of the control system 4.

The second embodiment has the advantages described below.

(6) Engagement of the lock member 51 with the turning actuator 45 restricts operation of the turning actuator 45. This restrict turning of the turning wheels 16 when the vehicle is parked.

(7) The lock member 51 engages an engagement portion (in one example, pinion teeth 27) to restrict rotation of a rotation shaft (in one example, pinion shaft 26) when the motor 11 is driven. This locks the turning wheels 16 and restricts turning of the turning wheels 16.

(8) The employment of the pinion teeth 27 as the engagement portion eliminates the need for a new engagement portion since the turning mechanism includes the rack and pinion mechanism 29 from the beginning. This reduces the number of components and the number of machining processes.

(9) The lock teeth 51a of the lock member 51 are pressed against the pinion teeth 27 so that the lock teeth 51a are meshed with the pinion teeth 27 to restrict rotation of the pinion shaft 26 when the motor 41 is driven. This restricts turning of the turning wheels 16.

It should be apparent to those skilled in the art that the foregoing embodiments may be implemented in many other specific forms without departing from the scope of this disclosure. Particularly, it should be understood that the foregoing embodiments may be implemented in the following forms.

In the first embodiment, as another example that does not require high power to restrict turning of the turning wheels 16, as long as interference can be avoided between the lock member 35 and the joint 22, the lock hole 34 may be arranged in the first output shaft 32 instead of the second output shaft 33 so that the lock member 35 is fitted to the lock hole 34 of the first output shaft 32. In this case, the second output shaft 33 may be omitted. Accordingly, the lock hole 34 may be arranged in the output shaft 42 of the motor 41 in the second embodiment. From the same viewpoint, to restrict the transmission of power before the power is reduced in speed by the reduction drive mechanism 23, the lock hole 34 may be arranged in the circumferential surface of the shaft of the drive gear 24 (one example of rotation shaft).

The pinion shaft 26 may include the lock hole 34, and the lock member 35 may be fitted to the lock hole 34 of the pinion shaft 26. This structure restricts the transmission of power that has been reduced in speed by the reduction drive mechanism 23.

In the second embodiment, as another example in which there is no need to add an engagement portion to the turning mechanism, the driven gear 25 or the drive gear 24 may be used as the engagement portion instead of the pinion teeth 27, and the lock teeth 51a of the lock member 51 may be meshed with the driven gear 25 or the drive gear 24.

The above-described embodiments and modified examples may be combined so that the turning mechanism includes a plurality of lock devices. This provides redundancy in which when the ECU of the control system 4 or another ECU controls each lock actuator to operate the lock devices in cooperation with one another and one of the lock devices cannot perform locking to restrict turning, the other lock devices perform locking. It is desirable that the lock device be fail-safe so that the lock member is located at the unlock position when the lock device becomes defective.

All examples and conditional language recited herein are intended for pedagogical purposes to aid the reader in understanding the principles of the invention and the concepts contributed by the inventors to furthering the art, and are to be construed as being without limitation to such specifically recited examples and conditions, nor does the organization of such examples in the specification relate to an illustration of the superiority and inferiority of the invention. Although embodiments have been described in detail, it should be understood that various changes, substitutions, and alterations could be made hereto without departing from the scope of this disclosure.

1. A lock device comprising:
a lock member arranged in a by-wire turning mechanism that turns a turning wheel by transmitting power of a turning actuator to a turning shaft,
wherein the lock member is moved between a lock position where the lock member is engaged with the turning actuator restricting operation of the turning actuator and an unlock position where the lock member is disengaged from the turning actuator permitting operation of the turning actuator.

2. The lock device according to claim 1, wherein
the turning actuator includes a motor that is a power source, and
when the lock member is located at the lock position, the lock member is engaged with an engagement portion of a rotation shaft that is rotated when the motor is driven.

3. The lock device according to claim 2, wherein
the turning actuator includes a reduction drive mechanism that reduces speed of rotation generated by the motor,
the rotation shaft is an output shaft of the motor, and the engagement portion is arranged in the output shaft of the motor.

4. The lock device according to claim 3, wherein:
the reduction drive mechanism includes a drive gear, which is coupled by a joint to the output shaft of the motor, and a driven gear, which is meshed with the drive gear;
the output shaft of the motor includes a first output shaft, which extends from a motor housing and is joined with the joint, and a second output shaft, which extends from the motor housing at a side opposite to the first output shaft; and
the engagement portion is arranged in the second output shaft.

5. The lock device according to claim 2, wherein
the turning actuator includes a pinion shaft including pinion teeth meshed with rack teeth of the turning shaft,
the rotation shaft is the pinion shaft, and
the engagement portion is the pinion teeth.

6. The lock device according to claim 5, wherein
the lock member includes lock teeth meshed with the pinion teeth, and
when the lock member is located at the lock position, the lock teeth are pressed against the pinion teeth in a direction intersecting the pinion shaft and meshed with the pinion teeth.
